(19) United States
(12) Patent Application Publication
(10) Pub. No.: US 2026/0270835 A1
(43) Pub. Date: Sep. 10, 2026

(54) APPARATUSES AND METHODS FOR FACILITATING AN ADAPTIVE, ROUTE SELECTION POLICY SYNCHRONIZATION TECHNIQUE TO ENHANCE COMMUNICATION NETWORKS AND SYSTEMS

(71) Applicant: AT&T Intellectual Property I, L.P., Atlanta, GA (US)

(72) Inventors: Nishit J. Sanghavi, Kenmore, WA (US); Chintan Shah, DUVALL, WA (US); Manjunath Besati, REDMOND, WA (US); Rohit Abhishek, Dawsonville, GA (US); Sean Simon, Lynnwood, WA (US); Farooq Bari, Kirkland, WA (US)

(73) Assignee: AT&T Intellectual Property I, L.P., Atlanta, GA (US)

(21) Appl. No.: 19/074,587

(22) Filed: Mar. 10, 2025

(51) Int. Cl. H04W 40/02; H04W 28/08; H04W 40/28

(52) U.S. Cl. CPC H04W 40/02; H04W 28/0925; H04W 40/28

(57) ABSTRACT

Aspects of the subject disclosure may include, for example, obtaining, from a network storage device, rules regarding policies of how user traffic is routed amongst a plurality of network slices of a network, analyzing, based on the obtaining, the rules to select a first route amongst a plurality of candidate routes for routing first user traffic, resulting in a first analysis, and routing, based on the first analysis, the first user traffic using the first route. Other embodiments are disclosed.

### FIELD OF THE DISCLOSURE

The subject disclosure relates to apparatuses and methods for facilitating an adaptive, route selection policy synchronization technique to enhance communication networks and systems.

### BACKGROUND

Vast communication networks and systems, and various communication devices, are utilized in a provisioning of communication services and sessions. Communications (or, analogously, signaling or traffic) between two or more entities involved in a transaction (e.g., a data transaction) may utilize one or more paths that may be selected from a plurality of candidate paths. Rules may dictate or define how user traffic and/or control traffic is routed across network slices based on, e.g., application and service subscriptions. The rules may be stored at/by a first entity (e.g., a user data repository [UDR]) and may be managed or enforced at/by a second entity (e.g., a policy control function [PCF]). In the context of a user equipment (UE) involved in the transaction, a third entity (e.g., an access and mobility management function [AMF]) may also aid in rules enforcement/application based on mobility of the UE.

While an arrangement involving the various entities described above may generally be effective, there could be various types of events, conditions, circumstances or the like that may cause the rules to become outdated or desynchronized amongst the various entities. Dependent on the nature of what transpires, the outdated or desynchronized rules amongst the various entities may result in misrouted traffic, service degradation, and loss of revenue for a network/system operator.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for facilitating an adaptive, route selection policy synchronization to enhance (the performance, efficiency, and reliability of) communication networks and systems. Other embodiments are described in the subject disclosure.

One or more aspects of the subject disclosure include, in whole or in part, obtaining, from a network storage device, rules regarding policies of how user traffic is routed amongst a plurality of network slices of a network; analyzing, based on the obtaining, the rules to select a first route amongst a plurality of candidate routes for routing first user traffic, resulting in a first analysis; and routing, based on the first analysis, the first user traffic using the first route.

One or more aspects of the subject disclosure include, in whole or in part, obtaining rules regarding policies of how user traffic is routed amongst a plurality of network slices of a network; identifying local conditions pertaining to at least quality of service and network congestion at an edge of the network; analyzing, based on the identifying, the rules to identify a modification to be made to the rules, resulting in a first analysis; modifying, based on the first analysis, the rules from a first version to a second version that is different from the first version; and selecting, based on the second version of the rules, a network slice of the plurality of network slices to route user traffic.

One or more aspects of the subject disclosure include, in whole or in part, identifying, by a processing system including a processor, an anomaly in a traffic pattern, a network slice, subscription data, or any combination thereof, based on a specification associated with a network, resulting in a first identification; identifying, by the processing system, a network condition of the network, resulting in a second identification; identifying, by the processing system and based on the first identification and the second identification, a modification to a policy for routing user traffic in the network, resulting in a third identification; and modifying, by the processing system and based on the third identification, the policy from a first version to a second version that is different from the first version.

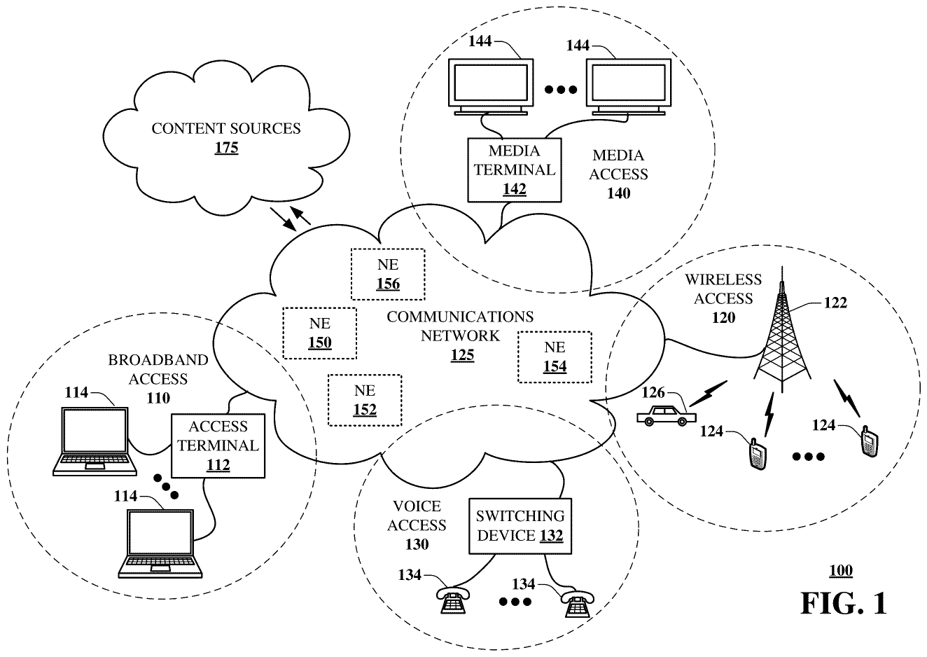

Referring now to FIG. 1, a block diagram is shown illustrating an example, non-limiting embodiment of a system 100 in accordance with various aspects described herein. For example, the system 100 can facilitate, in whole or in part, obtaining, from a network storage device, rules regarding policies of how user traffic is routed amongst a plurality of network slices of a network, analyzing, based on the obtaining, the rules to select a first route amongst a plurality of candidate routes for routing first user traffic, resulting in a first analysis, and routing, based on the first analysis, the first user traffic using the first route. The system 100 can facilitate, in whole or in part, obtaining rules regarding policies of how user traffic is routed amongst a plurality of network slices of a network, identifying local conditions pertaining to at least quality of service and network congestion at an edge of the network, analyzing, based on the identifying, the rules to identify a modification to be made to the rules, resulting in a first analysis, modifying, based on the first analysis, the rules from a first version to a second version that is different from the first version, and selecting, based on the second version of the rules, a network slice of the plurality of network slices to route user traffic. The system 100 can facilitate, in whole or in part, identifying, by a processing system including a processor, an anomaly in a traffic pattern, a network slice, subscription data, or any combination thereof, based on a specification associated with a network, resulting in a first identification, identifying, by the processing system, a network condition of the network, resulting in a second identification, identifying, by the processing system and based on the first identification and the second identification, a modification to a policy for routing user traffic in the network, resulting in a third identification, and modifying, by the processing system and based on the third identification, the policy from a first version to a second version that is different from the first version.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of tis disclosure may provide a system and method for enhancing management of rules, policies, standards, procedures, and the like in respect of a provisioning of communication services and sessions. For example, aspects of this disclosure may utilize a route selection policy (RSP) that may be applied to one or more entities (e.g., one or more devices, such as a user equipment [UE]). In this respect, a UE route selection policy (URSP) may be utilized to facilitate intelligent routing involving a UE.

URSP rules may correspond to, or include, a set of policies used in networks/systems to determine how traffic (e.g., user traffic) is routed across different slices based on application and service subscriptions. These rules may be managed by the Policy Control Function (PCF) and stored in the User Data Repository (UDR) in some embodiments. URSP rules may help ensure that traffic is directed through the most appropriate network/system resources, enhancing (e.g., optimizing) network/system performance and user experience. The rules may be crucial for maintaining service quality, especially during network/system transitions, during network/system update or maintenance activities, and for aligning with user-specific subscription details and operator-defined policies.

Rules management processes and techniques of this disclosure may enhance observability and synchronization of rules between various entities (e.g., a UE, PCF, and UDR), with support for both network/system-initiated mechanisms and UE-initiated mechanisms. Artificial intelligence (AI) and/or machine learning (ML) may be employed to predict enhanced (e.g., optimal) rules based on network/system conditions, detect anomalies in traffic patterns, network slices, or subscription data, and facilitate decision-making for updating/modifying, deleting/removing, and/or installing new rules. In some embodiments, such decision-making may be performed without querying an entity (e.g., a UE). In some embodiments, a network data analytics function (NWDAF) may be utilized to support data-driven insights and predictive analytics. Federated learning may ensure that models (which may be based on AI and/or ML) are trained across distributed platforms/topologies, while at the same time ensuring privacy/security in respect of sensitive data. In this respect, aspects of this disclosure may enhance an ability to adapt to dynamic conditions and user behaviors.

Aspects of this disclosure may involve various entities, such as for example a user equipment (UE), a policy control function (PCF), a user data repository (UDR), and/or an operator-specific data (OSD). The UE may apply URSP rules received from the PCF for routing traffic across network slices according to the user's subscription and application-specific policies (potentially inclusive of application version). The UE can trigger UE-initiated synchronization by requesting updated URSP rules during transitions between networks or technologies (e.g., from LTE to 5G NR), or based on an expiration of a subscription. The PCF may manage and enforce URSP rules based on a user's subscription and operator policies. The PCF may retrieve the URSP rules stored in the UDR and compare the retrieved rules with the OSD to decide what URSP rules need to be sent/provided to the UE. The PCF can initiate updates (network-initiated) or respond to requests from the UE (UE-initiated) to ensure policy consistency. The UDR may contain a dedicated URSP container that stores the URSP rules currently installed on the UE. The UDR may hold/store the OSD, which may include information pertaining to subscription details, service tiers, and operator policies that govern the URSP rules for one or more users. The OSD may correspond to a dataset that contains information about user subscriptions, including service levels, quality of service (QoS) requirements, network/system slice configurations, and operator-defined policies. The PCF may compare the OSD with the URSP rules stored in the UDR to determine whether any updates are necessary or appropriate.

In some embodiments, the UDR may store a URSP container that holds a copy of the URSP rules currently installed on a UE. When the PCF installs URSP rules on the UE, the PCF may update the URSP container in the UDR to reflect the current state of the UE's policies. In this respect, the URSP container may conform to a structure that includes URSP rules, a timestamp, and expiry information. The URSP rules may include the specific routing policies that are currently active or in-force on the UE (and potentially historical information pertaining to past routing policies). The timestamp may indicate when the URSP rules were last installed or updated/modified. The expiry information may specify when the URSP rules or the user's subscription will expire.

As set forth above, in some embodiments network-initiated (or, analogously, system-initiated) rules updates/synchronizations may be provided. In network-initiated rules synchronization, the PCF may initiate URSP rule updates based on network events or operator-defined triggers. These events may include subscription updates, network transitions, and/or periodic policy checks. In terms of subscription updates, when a user's subscription plan changes (e.g., upgrading to a higher-tier service), the PCF may retrieve the URSP rules from the UDR and compare the retrieved rules with the updated subscription information stored in the OSD. The PCF may determine whether new URSP rules need to be sent/provided to the UE based on a result of the comparison. In terms of network transitions, when the UE moves between networks (e.g., from LTE to 5G NR, or vice versa), the PCF may automatically retrieve the URSP rules from the UDR and compare them with the OSD to ensure the rules are aligned with the user's current subscription. If discrepancies are identified, the PCF may send the updated URSP rules to the UE. In terms of periodic policy checks, the PCF may periodically check the synchronization status of the URSP rules between the UE and UDR. If any misalignment is detected (e.g., rules on the UE are outdated), the PCF may initiate an update.

As set forth above, in some embodiments UE-initiated (or, analogously, communication device-initiated) rules updates/synchronizations may be provided. In UE-initiated rules synchronization, the UE may trigger the process of an update by sending a request for updated URSP rules to, e.g., the PCF. This triggering may occur when a network transition occurs or based on URSP expiry. In terms of a network transition occurring, when the UE moves from LTE to 5G NR (for example), the UE may send a policy request to the PCF, asking for the URSP rules applicable in the 5G environment. Based on receiving the policy request, the PCF may retrieve the last known URSP rules from the UDR, compare the retrieved rules with the OSD, and send updated rules to the UE if necessary. In terms of the URSP expiry, when a UE detected that its URSP subscription is about to expire, the UE may send a request to the PCF for new or updated URSP rules. Based on receiving the request for the new or updated URSP rules, the PCF may retrieve any required data from the UDR and/or OSD, may determine the appropriate policies, and may send updated rules to the UE as necessary/appropriate.

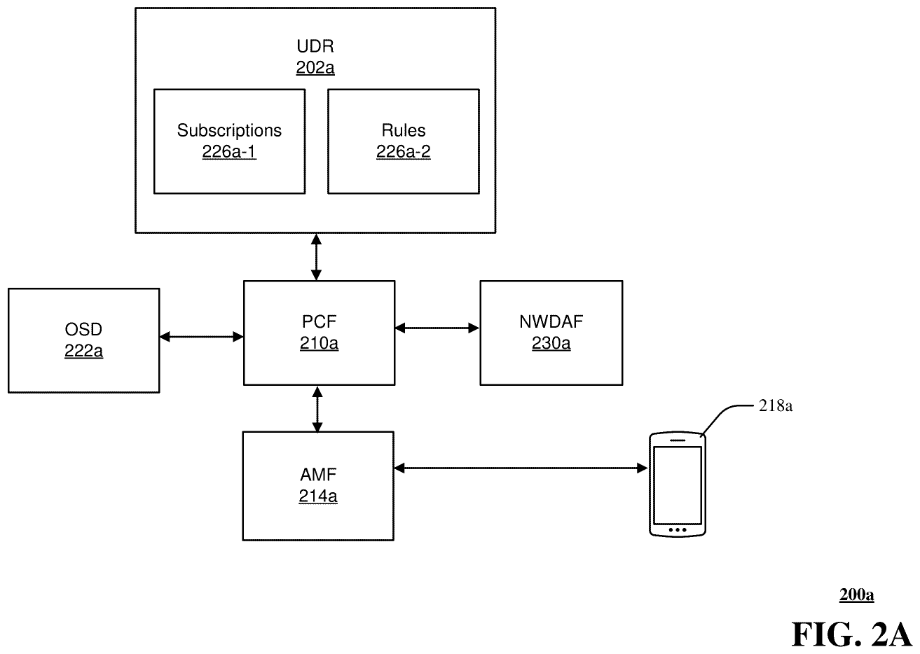

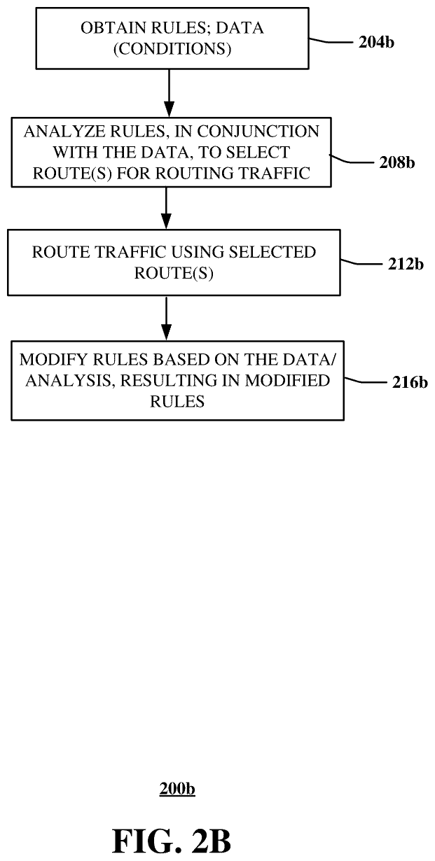

With the foregoing in mind, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1.

The system may include a UDR 202a, a PCF 210a, an AMF 214a, a UE 218a, and an OSD 222a. The UDR 202a may store or hold information pertaining to subscriptions 226a-1 and rules 226a-2, potentially in conjunction with one or more containers or containerized services. The subscriptions 226a-1 may contain information defining user service entitlements. The rules 226a-2 may contain information pertaining to the last-known URSP rules installed on the UE 218a, which in turn may pertain to specific routing policies currently active, or otherwise pertaining to, the UE 218a, potentially in conjunction with timestamp information indicating when the rules were last installed or updated and expiry information specifying when the rules (or a subscription) will expire.

In operation, the PCF 210a may retrieve the last-known URSP rules from the rules 226a-2 and compare the retrieved rules to data/information from the OSD 222a. Based on this comparison, the PCF 210a may determine if the URSP rules are still valid or if they require update/modification. If the URSP rules are outdated or misaligned relative to the data/information of the OSD 222a, the PCF 210a may generate new URSP rules and may have them sent/provided to the UE 218a by way of the AMF 214a. The new URSP rules may also be saved/stored in respect of the rules 226a-2 by way of an update initiated by the PCF 210a. By virtue of the aforementioned operations, synchronization of URSP rules may be provided across a communication network/system, which may aid in preventing service degradation. Further, it is noted that the arrangement shown in FIG. 2A is illustrative, which is to say that modifications may be made without departing from the scope and spirit of this disclosure. For example, in some embodiments two or more of the entities that are shown may be combined within a common housing or casing.

As described above, aspects of this disclosure may reduce (or even completely eliminate) dependencies on a UE for URSP policy decisions. For example, by having the subscriptions 226a-1 and the rules/policies 226a-2 stored at/in the system/network infrastructure, it is possible to facilitate decision-making processes/logic without having to query the UE 218a regarding the UE 218a configuration in terms of rules currently in force on/at the UE 218a.

Anytime a set of rules or policies is successfully installed on the UE 218a, the PCF 210a may obtain a notification from the AMF 214a of the same. Based on that notification, the PCF 210a may enforce/cause an update to the UDR 202a (e.g., to the rules 226a-2). If a writing/installation of rules or policies on the UE 218a fails, the PCF 210a may take no action, or the PCF 210a may (re-)write the old/existing policy/rule set to the UDR 202a. In either case pertaining to a failure, the user's subscription (as contained within the subscriptions 226a-1) may be out-of-sync with respect to the rules/policies on the UE 218a (as fairly represented within the rules 226a-2). If left unaddressed, this could result in the user/UE 218a obtaining services that the user/UE 218a is not entitled to, which may result in a loss of revenue for a network/system operator, or it could result in the user/UE 218a failing to obtain services that the user/UE 218a is entitled to, which may result in a degraded experience for the user. By maintaining the subscription information/status on the UDR 202a (e.g., as part of the subscriptions 226a-1), this out-of-sync condition may be detected and one or more corrective actions may be initiated in respect of the UE 218a to prevent service degradation for the user or revenue loss for the network/system operator.

As described above, aspects of this disclosure may incorporate AI and/or ML to facilitate synchronization and updates of rules or policies. A UE of this disclosure may be configured to apply URSP rules received from a PCF for routing traffic across resources (e.g., network slices). The UE may support federated learning, contributing data for model training without sharing sensitive/private information. The PCF may manage URSP rules by retrieving data from a UDR and applying AI/ML models to predict and decide on policy updates. The PCF may interact with a NWDAF (e.g., NWDAF 230a of FIG. 2A) to gather network insights and predictive analytics for enhanced (e.g., optimal) decision-making. In some embodiments, the UDR may store URSP rules and OSD. The UDR may integrate with AI-driven or ML-driven data analysis tools to detect inconsistencies or performance issues in URSP rules, facilitating timely updates and optimizations. The NWDAF may collect and analyze data across the network/system, providing AI/ML-driven insights to the PCF for predictive decision-making. NWDAF may support a detection of anomalies, provide traffic pattern analyses, and perform/provide optimizations for URSP rules. The OSD may contain information about a user's subscription, including QoS requirements and service level agreements (SLAs). The AI/ML models that are utilized may analyze OSD in real-time, or near real-time, to ensure that URSP rules are aligned with the user's subscription and network/system conditions.

In some embodiments, AI/ML algorithms may be used to predict optimal URSP rules based on real-time network/system conditions, user behaviors, and traffic patterns. Generative AI may be employed to simulate different network/system scenarios and suggest URSP rules for given conditions, improving the efficiency of URSP rule updates. AI/ML models of this disclosure may predict which URSP rules will provide the best performance (or meet some other performance criteria or metric) based on historical data, current network/system loads, and user behaviors. These models may predict when a user is likely to move between LTE and 5G NR (for example) and pre-emptively adjust URSP rules. AI/ML models of this disclosure may detect anomalies in traffic patterns or URSP rule applications, such as misrouted traffic or inconsistent QoS delivery. If an anomaly is detected, a PCF can initiate a network-initiated synchronization process to address/correct the issue. AI/ML models of this disclosure may analyze network/system-wide traffic data to determine a network/system slice allocation for different types of user traffic, ensuring that URSP rules are updated to provide the best possible performance (or to satisfy some other criteria).

Aspects of this disclosure may employ or utilize generative AI. Generative AI may enhance observability as part of a digital twin architecture by providing advanced predictive and analytical capabilities that help monitor and optimize systems/networks more efficiently. As part of the digital twin, observability tools may track real-time metrics, logs and traces. Generative AI may take the analysis further by predicting future states, identifying potential issues, and optimizing system behavior in a proactive manner/fashion. By analyzing vast amounts of data generated from both physical and virtual models, generative AI can forecast failures, service degradations, or rule violations, and may develop solutions to address the same.

In accordance with aspects of this disclosure, generative AI models may simulate network/system conditions and generate potential URSP rules. A PCF may evaluate the generated rules before deploying the same to a UE. These techniques may help the PCF anticipate network/system changes and apply proactive URSP rule adjustments. Furthermore, generative AI models may be used to simulate service degradation scenarios based on current network/system conditions and suggest URSP rule modifications to prevent user experience degradation.

A federated learning approach may train AI/ML models across distributed UEs without sharing raw user data. This may help to ensure that AI models can learn from network-wide/system-wide patterns without compromising user privacy or security. UEs may locally train AI models on their specific traffic patterns and URSP rule usages. These models may then be aggregated at the network/system level to improve the overall accuracy of AI/ML models used by, e.g., the PCF. The PCF may aggregate the trained models from multiple UEs, updating centralized AI/ML models (potentially without accessing individual user data). This may enhance an ability to predict optimal URSP rules (or rules that satisfy some other criteria) while preserving privacy.

As described above, NWDAF may play a role in providing real-time insights and analytics to a PCF. By leveraging AI/ML models within NWDAF, a continuous monitoring of network/system traffic, usage patterns, and performance metrics may be realized/obtained to inform URSP rule synchronization decisions. A NWDAF may collect and analyze traffic data across the network/system, providing insights into traffic loads, congestion points, and slice performance. This data may be provided to AI/ML models to help the PCF make informed decisions about URSP rule updates. The NWDAF's AI/ML models may detect anomalies in network performance, such as underperforming network slices or misrouted traffic. If an anomaly is detected, NWDAF may trigger the PCF to initiate a network-initiated synchronization of URSP rules. NWDAF's predictive analytics capabilities may provide a forecast of network/system conditions and traffic patterns. These predictions may be used by the PCF's AI/ML models to proactively adjust URSP rules to prevent service degradation.

Aspects of this disclosure may facilitate autonomous networks/systems for self-optimizing URSP. For example, AI/ML may be utilized to automate the operation and optimization of network/system functions without human intervention. In the context of URSP management, autonomous networks/systems may allow for self-optimizing URSP rule adjustments that continuously monitor, adapt, and enhance (e.g., optimize) traffic routing policies across the network/system.

As set forth above, a monitoring of traffic, slice utilization, and user (or application) QoS requirements in real-time may be provided. AI/ML models may be used to dynamically adjust URSP rules based on the network's/system's real-time performance. The models may be integrated with the PCF, UDR, and/or NWDAF to automate decisions about traffic routing, network slice assignments, and URSP rule updates, potentially without manual intervention.

To the extent that any anomalies are identified during monitoring operations, self-healing algorithms may determine that URSP rules are misaligned (e.g., due to network/system congestion or an overloaded slice, for example). AI/ML incorporated as part of such algorithms may automatically correct and re-optimize the URSP rules, potentially in real-time, to address such anomalies. For example, if a network slice becomes congested, the autonomous network may dynamically reroute traffic based on pre-learned optimization strategies without needing/requiring human intervention.

AI/ML predictive models may analyze historical traffic data and current network/system conditions to predict future states. Based on these predictions, the network/system can proactively adjust URSP rules before congestion or performance issues occur. To demonstrate, if AI/ML modeling predicts a spike in mobile gaming traffic in a specific area, the URSP rules may be adjusted to prioritize low-latency slices for gaming traffic ahead of time, ensuring a seamless user experience.

Aspects of this disclosure may operate in a closed-loop manner or fashion, whereby data/information pertaining to performance, traffic patterns, and user behaviors may be continuously fed into one or more models. The models may evaluate the state, identify optimization opportunities, adjust URSP rules accordingly, and then monitor the results to further refine the decision-making processes/logic. NWDAF may be utilized as part of these processes/procedures by collecting and analyzing data across a network/system, with the results of the analysis being provided/fed to models within the PCF or any edge nodes to enhance (e.g., optimize) URSP rule adjustments.

Predictive models of this disclosure may use techniques like recurrent neural networks (RNNs) or long short-term memory (LSTM) networks to forecast traffic demand, enabling adjustments to URSP rules preemptively. Reinforcement learning (RL) algorithms may be deployed in the PCF and edge nodes to continuously learn from traffic patterns and autonomously adjust URSP rules. RL enables decisions to be made based on long-term performance goals, such as reducing (e.g., minimizing) latency or enhancing (e.g., maximizing) throughput, without sacrificing short-term performance. AI-driven and/or ML-driven anomaly detection models of this disclosure may continuously monitor URSP enforcement actions and detect any discrepancies between expected and actual traffic routing outcomes. When anomalies are detected, a self-healing URSP update may be initiated or triggered, rerouting traffic or adjusting policies to address/resolve issues.

Autonomous networks/systems use AI and ML to automatically allocate and enhance (e.g., optimize) slice resources, potentially in real-time. The models of this disclosure continuously evaluate slice performance and adjust URSP rules to ensure users are routed to the best slice (or some other slice meeting some specified criteria) based on traffic type and QoS requirements, for example.

A model of this disclosure may continuously monitor traffic, slice (or other resource) utilization, and user-specific or application-specific QoS requirements. Based on the monitoring, if suboptimal performance (e.g., a congested slice or degraded QoS) is detected/identified, reinforcement learning models in the PCF or edge nodes may autonomously decide to adjust URSP rules based on pre-learned strategies. Models and algorithms of this disclosure may autonomously update URSP rules, re-route traffic, or adjust slice (or other resource) assignments as needed to enhance (e.g., optimize) performance. If a policy anomaly or fault is detected, AI/ML technologies of this disclosure may trigger self-healing mechanisms, dynamically recalibrating the URSP rules and rerouting traffic through unaffected resources (e.g., unaffected network slices). An impact of adjustments that are initiated may be monitored or evaluated, with feedback regarding the same being provided/obtained to enhance future decisions.

As set forth above, aspects of this disclosure may provide a fully automated network/system that eliminates a need for human/manual intervention. Of course, aspects of this disclosure may enable user/human participation as part of one or more processes.

As one skilled in the art will appreciate, edge computing enables computational operations to reside at an edge of a network or system. This location may help to reduce latency and allow for faster, real-time decisions to be made and enacted. In the context of URSP management, edge computing can enhance both network-initiated and UE-initiated URSP synchronization by enabling localized, real-time decision-making for policy/rules updates and traffic routing.

As part of edge computing, edge nodes (e.g., Multi-Access Edge Computing (MEC) servers) may be deployed close to a Radio Access Network (RAN) and can make real-time decisions about URSP rule updates. By processing network traffic and user-specific data locally, edge nodes may reduce latency and improve the speed of URSP rule enforcement. Edge nodes can apply AI/ML models locally to predict enhanced (e.g., optimal) URSP rules based on real-time traffic, network/system loads, and user behaviors. This allows for low-latency updates to URSP rules as the network/system conditions change.

When a UE connects to a network/system, an edge node may monitor the resources (e.g., the network slice) that the UE uses, traffic patterns involving the UE (and potentially other UEs), and QoS parameters. Based on this information, the edge node may make decisions about URSP updates, potentially without needing to query the centralized PCF. To demonstrate, if a UE moves into a congested area, the edge node may adjust the UE's URSP rules to route traffic through a less congested network slice, ensuring service continuity and improved user experience.

Edge AI models may be deployed on MEC servers to analyze local traffic patterns and resource (e.g., network slice) performance and/or to predict traffic congestion, user behaviors, or changes in QoS requirements. Adjustments may be made to URSP rules for users within the edge node's geographical/coverage area. For example, if a spike/large increase in video streaming traffic is detected or identified, a model may initiate a change to prioritize traffic for premium users by dynamically updating URSP rules to allocate more bandwidth or adjust a resource allocation to a different network slice. By virtue of this decision-making logic/processes, overall performance and a reduction in latency may be realized/obtained.

In some embodiments, a selection of a slice may be obtained. The selection may correspond to one or more slices from a set of pre-configured slices. In some embodiments, a new slice may be generated and allocated, or a modification may be made to an existing slice to generate a new, modified slice. Various parameters and resources may be adapted or modified in conjunction with creating/generating and/or maintaining slices.

Various models of this disclosure may leverage supervised learning for traffic classification. Reinforcement learning may be utilized for dynamic URSP rule adjustments.

UEs may locally train AI/ML models based on their own usage data and upload the model updates to edge servers. This may enable a distributed learning environment without compromising user privacy or security. The edge nodes of this disclosure may aggregate these models and make decisions about traffic routing and URSP rule updates in a privacy-preserving way.

Even though edge nodes may handle localized URSP updates, the PCF and the UDR (which may be located in a core network/system) may stay synchronized with these updates. Edge nodes can report URSP rule changes to the PCF to ensure that the UE's URSP rules remain in-sync with the core network, reducing (e.g., avoiding) policy conflicts.

By moving URSP processing closer to UEs, edge computing reduces latency in URSP rule updates. In turn, this may ensure real-time traffic routing adjustments without the delays caused by/attributable to centralized processing.

As a UE sends traffic, an edge node (e.g., a MEC server) may monitor traffic patterns and current network slice performance characteristics. An edge AI/ML model may process the traffic and predict whether an adjustment in URSP rules is needed based on local conditions (e.g., network/system congestion or QoS requirements). If the model predicts a need for enhancement (e.g., optimization), an edge node may modify the URSP rules and enforce them locally, rerouting traffic or adjusting the resources (e.g., the network slice(s) that are utilized), accordingly. The edge node may send a report to the centralized PCF about the URSP rule changes it has applied to ensure that the UDR and PCF are synchronized in accordance with the edge-enforced rules.

As one skilled in the art will appreciate, edge computing for URSP management may provide a number of benefits/enhancements. For example, real-time URSP decisions at the edge may reduce latency relative to an arrangement relying on centralized processing. AI or ML models at the edge may enhance qualities or characteristics of URSP rules based on real-time, local network/system conditions. Decentralized decision-making at edge nodes may provide for more scalable URSP management, particularly in relation to dense, high-traffic areas (e.g., urban areas).

Referring now to FIG. 2B, an illustrative embodiment of a method 200b in accordance with various aspects described herein is shown. The method 200b may be implemented or executed, in whole or in part, in conjunction with one or more systems, devices, and/or components, such as for example the systems, devices, and components set forth herein. In some embodiments, the method 200b may be wholly or partially implemented or executed via one or more processing systems, where each such processing system may include one or more processors. Further, in some embodiments, operations of the method 200b may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200b are described below in relation to the blocks shown in FIG. 2B. In some embodiments, one or more blocks or operations may be based on one or more other blocks or operations.

In block 204b, (a copy of) rules may be obtained. For example, block 204b may include obtaining the rules from a network/system storage device (e.g., a memory, a database, etc.). The rules may include or pertain to policies of how traffic (e.g., user traffic) is routed amongst a plurality of (network) slices of a network/system.

As part of block 204b, data may be obtained. The data may pertain to network/system conditions, changes in the network/system (such as change in load accommodated/supported by the network/system, changes in an application executed/supported by the network/system or client devices/user equipment, changes in a configuration, etc.), etc.

In block 208b, the rules (of block 204b) may be analyzed, potentially in conjunction with the data (of block 204b), to select one or more routes for routing traffic. In some embodiments, the selected route(s) may include one or more resources (e.g., one or more slices).

In block 212b, traffic may be routed in accordance with the route(s) selected as part of block 208b. For example, first user traffic may be routed via a first route and second user traffic may be routed via a second route; the second route may be the same as, or different from, the first route.

In block 216b, the rules may be modified based on the data (of block 204b) and/or the analysis (of block 208b). For example, as part of block 216b it may be determined that the rules (of block 204b) are outdated, suboptimal for local network conditions, etc. Block 216b may include a modification of the rules from a first version to a second version that is different from the first version. In this regard, the modified rules (e.g., the second version) may be saved/stored for future uses (e.g., future executions of the method 200b). Stated differently, aspects of the method 200b may be executed iteratively or repeatedly, with an ability to accommodate or respond to changes in conditions or circumstances via a modification of the rules or policies that are utilized as part of the process of routing traffic.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Various embodiments of this disclosure may implement version controls to facilitate modifications. For example, rules, policies, procedures, applications, configurations, and the like, may be subject to an assignment or an allocation of a version. To demonstrate, a rule may be modified from a first version to a second version that is different from the first version. Timestamps, file version numbers, or the like may be used to track changes, which may facilitate record-keeping, audit activities, and the like.

Aspects of this disclosure may provide advanced techniques for synchronizing URSP rules across networks/systems by leveraging cutting-edge technologies, such as AI/ML, generative AI, and federated learning. Unlike traditional methods that require direct querying of UEs, aspects of this disclosure enable both network-initiated and UE-initiated synchronization by utilizing data stored in the UDR and comparing this data with OSD. The integration with the NWDAF enhances decision-making processes through AI/ML models and predictive insights, allowing for continuous policy synchronization and anomaly detection without direct UE interaction. This approach not only enhances (e.g., optimizes) network/system performance and ensures policy consistency, but also introduces a privacy-preserving mechanism through federated learning, which allows AI models to be trained across distributed devices without sharing sensitive data. Additionally, the ability to predict optimal URSP rules and detect anomalies in real-time significantly improves network/system efficiency and customer/subscriber satisfaction, which is a distinction relative to existing technologies.

As demonstrated herein, the various aspects of this disclosure are directed to, and integrated within, numerous practical applications involving a provisioning of communication services and sessions. As one skilled in the art will appreciate, the various aspects of this disclosure represent substantial improvements to technologies involved in managing network/system resources and ensuring high levels of quality of service and quality of experience are provided to client devices/user equipment (UEs). In this respect, the various aspects of this disclosure are not directed to abstract ideas. To the contrary, the various aspects of this disclosure are directed to, and encompass, significantly more than any abstract idea standing alone. Indeed, the various aspects of this disclosure facilitate the generation of useful, concrete, tangible, and transformative results.

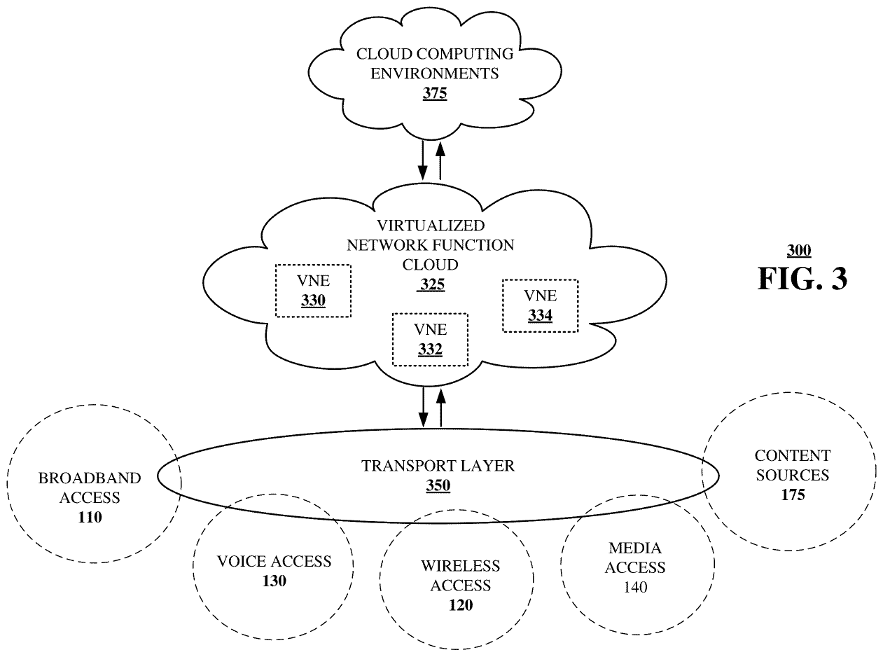

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, the virtualized communication network 300 can facilitate, in whole or in part, obtaining, from a network storage device, rules regarding policies of how user traffic is routed amongst a plurality of network slices of a network, analyzing, based on the obtaining, the rules to select a first route amongst a plurality of candidate routes for routing first user traffic, resulting in a first analysis, and routing, based on the first analysis, the first user traffic using the first route. The virtualized communication network 300 can facilitate, in whole or in part, obtaining rules regarding policies of how user traffic is routed amongst a plurality of network slices of a network, identifying local conditions pertaining to at least quality of service and network congestion at an edge of the network, analyzing, based on the identifying, the rules to identify a modification to be made to the rules, resulting in a first analysis, modifying, based on the first analysis, the rules from a first version to a second version that is different from the first version, and selecting, based on the second version of the rules, a network slice of the plurality of network slices to route user traffic. The virtualized communication network 300 can facilitate, in whole or in part, identifying, by a processing system including a processor, an anomaly in a traffic pattern, a network slice, subscription data, or any combination thereof, based on a specification associated with a network, resulting in a first identification, identifying, by the processing system, a network condition of the network, resulting in a second identification, identifying, by the processing system and based on the first identification and the second identification, a modification to a policy for routing user traffic in the network, resulting in a third identification, and modifying, by the processing system and based on the third identification, the policy from a first version to a second version that is different from the first version.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

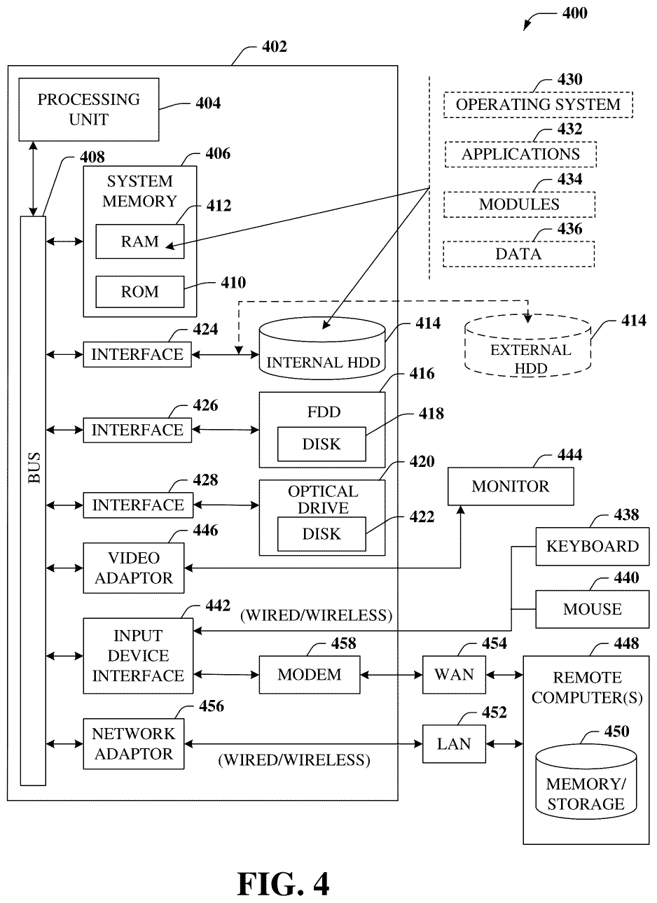

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining, from a network storage device, rules regarding policies of how user traffic is routed amongst a plurality of network slices of a network, analyzing, based on the obtaining, the rules to select a first route amongst a plurality of candidate routes for routing first user traffic, resulting in a first analysis, and routing, based on the first analysis, the first user traffic using the first route. The computing environment 400 can facilitate, in whole or in part, obtaining rules regarding policies of how user traffic is routed amongst a plurality of network slices of a network, identifying local conditions pertaining to at least quality of service and network congestion at an edge of the network, analyzing, based on the identifying, the rules to identify a modification to be made to the rules, resulting in a first analysis, modifying, based on the first analysis, the rules from a first version to a second version that is different from the first version, and selecting, based on the second version of the rules, a network slice of the plurality of network slices to route user traffic. The computing environment 400 can facilitate, in whole or in part, identifying, by a processing system including a processor, an anomaly in a traffic pattern, a network slice, subscription data, or any combination thereof, based on a specification associated with a network, resulting in a first identification, identifying, by the processing system, a network condition of the network, resulting in a second identification, identifying, by the processing system and based on the first identification and the second identification, a modification to a policy for routing user traffic in the network, resulting in a third identification, and modifying, by the processing system and based on the third identification, the policy from a first version to a second version that is different from the first version.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

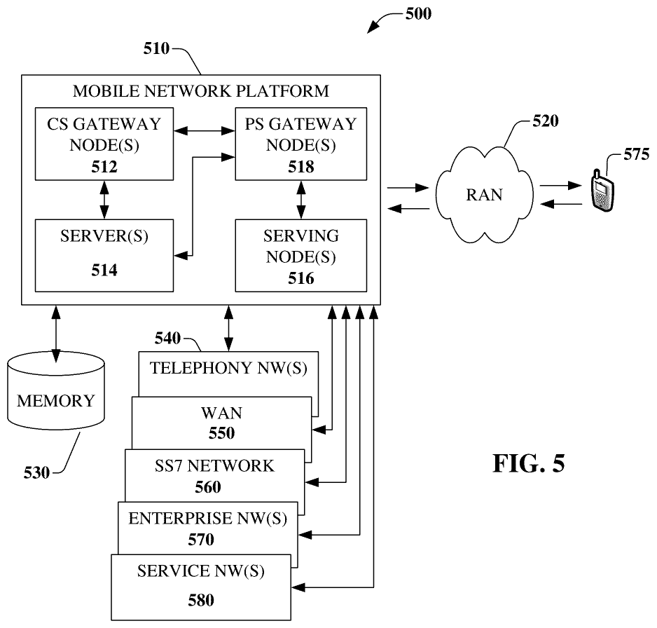

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining, from a network storage device, rules regarding policies of how user traffic is routed amongst a plurality of network slices of a network, analyzing, based on the obtaining, the rules to select a first route amongst a plurality of candidate routes for routing first user traffic, resulting in a first analysis, and routing, based on the first analysis, the first user traffic using the first route. The platform 510 can facilitate, in whole or in part, obtaining rules regarding policies of how user traffic is routed amongst a plurality of network slices of a network, identifying local conditions pertaining to at least quality of service and network congestion at an edge of the network, analyzing, based on the identifying, the rules to identify a modification to be made to the rules, resulting in a first analysis, modifying, based on the first analysis, the rules from a first version to a second version that is different from the first version, and selecting, based on the second version of the rules, a network slice of the plurality of network slices to route user traffic. The platform 510 can facilitate, in whole or in part, identifying, by a processing system including a processor, an anomaly in a traffic pattern, a network slice, subscription data, or any combination thereof, based on a specification associated with a network, resulting in a first identification, identifying, by the processing system, a network condition of the network, resulting in a second identification, identifying, by the processing system and based on the first identification and the second identification, a modification to a policy for routing user traffic in the network, resulting in a third identification, and modifying, by the processing system and based on the third identification, the policy from a first version to a second version that is different from the first version.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

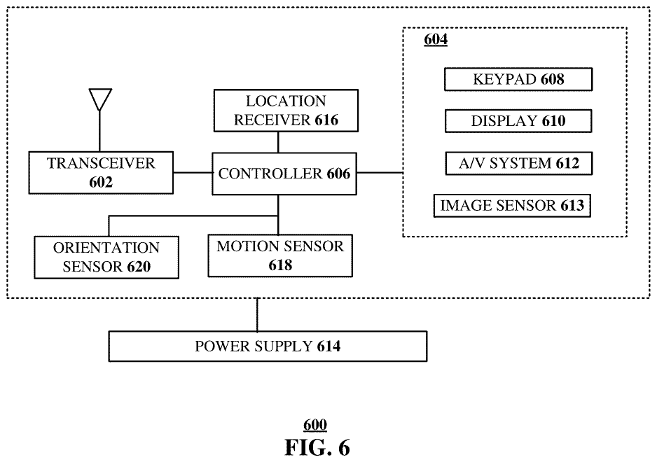

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining, from a network storage device, rules regarding policies of how user traffic is routed amongst a plurality of network slices of a network, analyzing, based on the obtaining, the rules to select a first route amongst a plurality of candidate routes for routing first user traffic, resulting in a first analysis, and routing, based on the first analysis, the first user traffic using the first route. The computing device 600 can facilitate, in whole or in part, obtaining rules regarding policies of how user traffic is routed amongst a plurality of network slices of a network, identifying local conditions pertaining to at least quality of service and network congestion at an edge of the network, analyzing, based on the identifying, the rules to identify a modification to be made to the rules, resulting in a first analysis, modifying, based on the first analysis, the rules from a first version to a second version that is different from the first version, and selecting, based on the second version of the rules, a network slice of the plurality of network slices to route user traffic. The computing device 600 can facilitate, in whole or in part, identifying, by a processing system including a processor, an anomaly in a traffic pattern, a network slice, subscription data, or any combination thereof, based on a specification associated with a network, resulting in a first identification, identifying, by the processing system, a network condition of the network, resulting in a second identification, identifying, by the processing system and based on the first identification and the second identification, a modification to a policy for routing user traffic in the network, resulting in a third identification, and modifying, by the processing system and based on the third identification, the policy from a first version to a second version that is different from the first version.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining, from a network storage device, rules regarding policies of how user traffic is routed amongst a plurality of network slices of a network;
analyzing, based on the obtaining, the rules to select a first route amongst a plurality of candidate routes for routing first user traffic, resulting in a first analysis; and
routing, based on the first analysis, the first user traffic using the first route.

2. The device of claim 1, wherein the operations further comprise:
identifying a change in the network;
analyzing, based on the identifying of the change in the network, the rules to select a second route amongst the plurality of candidate routes for routing second user traffic, resulting in a second analysis; and
routing, based on the second analysis, the second user traffic using the second route.

3. The device of claim 2, wherein the first route utilizes a first network slice of the plurality of network slices and the second route utilizes a second network slice of the plurality of network slices, and wherein second network slice is different from the first network slice.

4. The device of claim 2, wherein the change in the network includes a change in a configuration of the network from a first configuration to a second configuration that is different from the first configuration.

5. The device of claim 2, wherein the change in the network includes a change in an application that is executed from a first version to a second version that is different from the first version.

6. The device of claim 2, wherein the change in the network includes a change in a load supported by the network from a first load to a second load that is different from the first load.

7. The device of claim 2, wherein the identifying of the change in the network is based on generating a prediction of the change.

8. The device of claim 7, wherein the generating of the prediction includes using machine learning, artificial intelligence, or a combination thereof.

9. The device of claim 1, wherein a copy of the rules is stored on a first user equipment, and wherein the routing of the first user traffic using the first route comprises routing the first user traffic to the first user equipment.

10. The device of claim 1, wherein the operations further comprise:
obtaining a trigger corresponding to a request to change the rules from a user equipment;
modifying, based on the obtaining of the trigger, the rules from a first version to a second version that is different from the first version;
providing the second version of the rules to the network storage device for storage at the network storage device; and
providing the second version of the rules to the user equipment for storage at the user equipment.

11. The device of claim 10, wherein the obtaining of the trigger is based on an expiration of a subscription associated with the user equipment.

12. The device of claim 10, wherein the obtaining of the trigger is based on a change in a radio access technology that is utilized by the user equipment from a first radio access technology to a second radio access technology that is different from the first radio access technology.

13. The device of claim 10, wherein the operations further comprise:
obtaining, from the network storage device, the second version of the rules;
analyzing, based on the obtaining of the second version of the rules, the second version of the rules to select a second route amongst the plurality of candidate routes for routing second user traffic, resulting in a second analysis; and
routing, based on the second analysis, the second user traffic to the user equipment using the second route.

14. The device of claim 1, wherein the operations further comprise:
comparing, based on the obtaining, the rules to operator specific data of an operator of the network;
determining, based on the comparing, that the rules are outdated or misaligned relative to a performance criteria;
generating, based on the determining, new rules; and
transmitting, based on the generating, the new rules to a user equipment.

15. The device of claim 14, wherein the operations further comprise:
transmitting the new rules to the network storage device for storage at the network storage device.

16. A non-transitory machine-readable medium, comprising executable instructions that, when executed by a processing system including a processor, facilitate performance of operations, the operations comprising:
obtaining rules regarding policies of how user traffic is routed amongst a plurality of network slices of a network;
identifying local conditions pertaining to at least quality of service and network congestion at an edge of the network;
analyzing, based on the identifying, the rules to identify a modification to be made to the rules, resulting in a first analysis;
modifying, based on the first analysis, the rules from a first version to a second version that is different from the first version; and
selecting, based on the second version of the rules, a network slice of the plurality of network slices to route user traffic.

17. The non-transitory machine-readable medium of claim 16, wherein at least a portion of the user traffic is routed to a user equipment, and wherein the operations further comprise:
obtaining an input from the user equipment, the input including data indicative of a usage of the user equipment.

18. The non-transitory machine-readable medium of claim 17, wherein the modification to be made to the rules is based on the input.

19. A method, comprising:
identifying, by a processing system including a processor, an anomaly in a traffic pattern, a network slice, subscription data, or any combination thereof, based on a specification associated with a network, resulting in a first identification;
identifying, by the processing system, a network condition of the network, resulting in a second identification;
identifying, by the processing system and based on the first identification and the second identification, a modification to a policy for routing user traffic in the network, resulting in a third identification; and
modifying, by the processing system and based on the third identification, the policy from a first version to a second version that is different from the first version.

20. The method of claim 19, further comprising:
routing, by the processing system and based on the second version of the policy, first user traffic using a first network slice; and
routing, by the processing system and based on the second version of the policy, second user traffic using a second network slice that is different from the first network slice.
